(19) United States
(12) Patent Application Publication
(10) Pub. No.: US 2012/0269095 A1
(43) Pub. Date: Oct. 25, 2012

(54) METHOD AND APPARATUS FOR PROVIDING A NETWORK SEARCH FUNCTION

(75) Inventors: Lars Dalsgaard, Oulu (FI); Klaus Franz Doppler, Berkeley, CA (US); Karol Drazynski, Wroclaw (PL)

(73) Assignees: Nokia Siemens Networks Oy; Nokia Corporation

(21) Appl. No.: 13/090,741

(22) Filed: Apr. 20, 2011

(51) Int. Cl. H04W 84/00; H04W 76/00

(52) U.S. Cl. 370/255

(57) ABSTRACT

A method for providing an autonomous search function may include discovering, at a user terminal, a first access node providing access in accordance with a first radio access technology (RAT), causing an attempt to discover a second access node providing access in accordance with a second RAT in response to discovering the first access node where the first access node has a first coverage area and the second access node has a second coverage area that at least partially overlaps with the first coverage area, and causing storage of fingerprint information associated with the first access node together with storage of fingerprint information associated with the second access node. An apparatus and computer program product corresponding to the method are also provided.

### TECHNOLOGICAL FIELD

Embodiments of the present invention relate generally to wireless communications technology and, more particularly, relate to a method and apparatus for providing a network search function.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. In order to provide easier or faster information transfer and convenience, telecommunication industry service providers are developing improvements to existing networks. In this regard, wireless communication has become increasingly popular in recent years due, at least in part, to reductions in size and cost along with improvements in battery life and computing capacity of mobile electronic devices. As such, mobile electronic devices have become more capable, easier to use, and cheaper to obtain. Due to the now ubiquitous nature of mobile electronic devices, people of all ages and education levels are utilizing mobile terminals to communicate with other individuals or contacts, receive services and/or share information, media and other content.

Communication networks and technologies have been developed and expanded to provide robust support for mobile electronic devices. For example, the universal mobile telecommunications system (UMTS) terrestrial radio access network (UTRAN) and the evolved UTRAN (E-UTRAN) continue to develop and be in use. The E-UTRAN, which is also known as Long Term Evolution (LTE) or 3.9G, is aimed at upgrading prior technologies by improving efficiency, lowering costs, improving services, making use of new spectrum opportunities, and providing better integration with other open standards. In a typical network configuration mobile users communicate with each other via communication links maintained by the network. In this regard, for example, an originating station may typically communicate data to network devices in order for the network devices to relay the data to a target station.

Recently, efforts have been made to enable the provision of closed subscriber groups (CSGs) to enable restricted access to particular cells for particular groups of subscribers. CSGs may be useful for particular organizations or businesses that wish to define a group of users that may be enabled to freely access a base station, node or access point associated with the CSG, but may have restrictions for enabling access to the cell by individuals outside of the group. CSGs may also be useful in connection with individually established networks within private homes. In this regard, for example, a CSG may typically define a group of users (e.g., subscribers) that are enabled to access a particular CSG cell. As such, individuals that are not members of the group may not be able to access the CSG cell. Hybrid cells may also exist as cells having a CSG indicator set to false, but also broadcast a closed subscriber group ID (CSG-ID). In some situations, subscribers may be members of multiple CSGs. In practice, a CSG may be associated with one or more cells served by access points, base sites, node-Bs (NBs), evolved NBs (eNBs), home node-Bs (HNBs) or home evolved node-Bs (HeNBs) that may provide access to subscribers of the CSG.

Current communication standards enable a particular mobile terminal or user equipment (UE) to discover possible CSG/hybrid cells with which the UE may attempt to communicate using an autonomous search function However, searching for CSG cells can consume time and power that could be preserved or devoted to other pursuits. Thus, it may be advantageous to develop ways to improve autonomous search procedures.

### BRIEF SUMMARY OF SOME EXAMPLES

A method, apparatus and computer program product are therefore provided to enable the provision of a mechanism by which to improve the accuracy of stored information that is descriptive of permitted or accessible CSG or hybrid femtocell locations. As such, for example, some embodiments may provide for the storage of CSG/hybrid related RF macro fingerprint information in connection with location information regarding a WiFi or other local access point. As such, location information regarding a smaller cell providing network access according to a first wireless protocol may be stored in connection with location information regarding a larger cell providing network access according to a second wireless protocol to be used in connection with improving the efficiency of autonomous search functions in connection with CSG cell discovery.

In an example embodiment, a method of providing an improved autonomous search function is provided. The method may include discovering, at a user terminal, a first access node providing access in accordance with a first radio access technology (RAT), causing an attempt to discover a second access node providing access in accordance with a second RAT where the first access node has a first coverage area and the second access node has a second coverage area that at least partially overlaps with the first coverage area, and causing storage of fingerprint information associated with the first access node in association with storage of fingerprint information associated with the second access node.

In another example embodiment, a computer program product for providing improved autonomous search function is provided. The computer program product includes at least one computer-readable storage medium having computer-executable program code instructions stored therein. The computer-executable program code instructions may include program code instructions for discovering, at a user terminal, a first access node providing access in accordance with a first radio access technology (RAT), causing an attempt to discover a second access node providing access in accordance with a second RAT where the first access node has a first coverage area and the second access node has a second coverage area that at least partially overlaps with the first coverage area, and causing storage of fingerprint information associated with the first access node in association with storage of fingerprint information associated with the second access node.

In another example embodiment, an apparatus for providing improved autonomous search function is provided. The apparatus may include at least one processor and at least one memory including computer program code. The at least one memory and the computer program code may be configured, with the at least one processor, to cause the apparatus to perform at least discovering, at a user terminal, a first access node providing access in accordance with a first radio access technology (RAT), causing an attempt to discover a second access node providing access in accordance with a second RAT where the first access node has a first coverage area and the second access node has a second coverage area that at least partially overlaps with the first coverage area, and causing storage of fingerprint information associated with the first access node in association with storage of fingerprint information associated with the second access node.

In yet another example embodiment, an apparatus for providing improved autonomous search function is provided. The apparatus may include means for discovering, at a user terminal, a first access node providing access in accordance with a first radio access technology (RAT), means for causing an attempt to discover a second access node providing access in accordance with a second RAT where the first access node has a first coverage area and the second access node has a second coverage area that at least partially overlaps with the first coverage area, and means for causing storage of fingerprint information associated with the first access node in association with storage of fingerprint information associated with the second access node.

In another example embodiment, an apparatus for providing improved autonomous search function is provided. The apparatus may include at least one processor and at least one memory including computer program code. The at least one memory and the computer program code may be configured, with the at least one processor, to cause the apparatus to perform at least receiving information, from a user terminal, indicative of a first access node providing access in accordance with a first radio access technology, receiving information indicative of a second access node providing access in accordance with a second radio access technology where the first access node may have a first coverage area and the second access node may have a second coverage area that at least partially overlaps with the first coverage area, directing storage of the information indicative of the first access node in association with the information indicative of the second access node, and in some examples also providing fingerprint information associated with the first access node together with fingerprint information associated with the second access node to one or more user terminals.

### BRIEF DESCRIPTION OF THE SEVERAL VIEWS OF THE DRAWING(S)

Having thus described some embodiments of the invention in general terms, reference will now be made to the accompanying drawings, which are not necessarily drawn to scale, and wherein:

FIG. 1 is a schematic block diagram of a system according to an example embodiment of the present invention;

FIG. 2 illustrates an apparatus for enabling the provision of an autonomous search function according to an example embodiment of the present invention;

FIG. 3 illustrates a flow chart showing some of the activities managed by a search manager according to an example embodiment;

FIG. 4 illustrates an example of the use of WiFi fingerprint information and cellular fingerprint information for triggering proximity indication messages according to an example embodiment;

FIG. 5 illustrates a network apparatus for supporting provision of an autonomous search function according to an example embodiment of the present invention;

FIG. 6 is a flowchart according to an example method for providing an autonomous search function at a user terminal according to an example embodiment of the present invention; and

FIG. 7 is a flowchart according to an example method for supporting an autonomous search function at a network node according to an example embodiment of the present invention.

### DETAILED DESCRIPTION OF SOME EMBODIMENTS

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Electronic devices continue to evolve in relation to their ability to provide mobile users with wireless connectivity. UTRAN and E-UTRAN mobile radio networks have continued to expand as mobile electronic device usage has exploded. With the accessibility of mobile electronic devices, many individuals and businesses have sought to define groups of users or subscribers that are enabled to access a particular CSG cell. A CSG may be associated with one or more cells served by access points, eNBs or home eNBs (e.g., femtocells) that may provide access to subscribers of the CSG.

User equipments (UEs) may be enabled to seek out supporting access points (e.g., CSG/hybrid femtocells. For example, UEs supporting CSG features and having non-empty whitelists may be configured to detect allowed or otherwise accessible CSG/hybrid cells in an idle mode using an autonomous search function (ASF). The ASF is to be supported on a serving carrier and also on non-serving frequencies including inter-RAT (radio access technology) frequencies. After allowed or accessible CSG/hybrid cells are detected and camped on successfully, the UE may be configured to memorize the cell location (e.g., by internally storing a macro layer fingerprint or RF (radio frequency) fingerprint) such that the next time the UE is in the same area, the ASF is enabled to find the previously visited and allowed or accessible CSG/hybrid cell.

The location information identifying the location of the CSG/hybrid cell may be used while the UE is in a connected mode. In some cases, the UE may be configured to send a proximity indication when the UE enters or leaves the proximity of one or more accessible CSG/hybrid cells. Thus, for example, when the UE is approaching or already in the vicinity of an allowed CSG/hybrid cell, the UE may send the corresponding serving eNB a proximity indication message. The proximity indication message may indicate to the serving eNB, home eNB or other access point that measurement configuration information is requested or indicate that other actions related to handover may be forthcoming. As such, the accuracy of the proximity indication message may impact the handover success rate, measurement overhead and UE battery life, among other things. For example, if the proximity indication message is received, but the UE is still out of range of the home eNB, the UE may still expend energy attempting to exchange measurement information and/or conduct handover-related functions, thereby wasting resources. Generally speaking, sending of proximity indications may vary with different modem implementations, and thus resource wastage may not be uncommon. However, if the proximity indication message could be issued at a more precise time relative to the ability to successfully impact handover success rate, measurement overhead, UE battery life, etc., may be enhanced. Some example embodiments may provide for improved accuracy and/or consistency in relation to proximity indications as described in greater detail below.

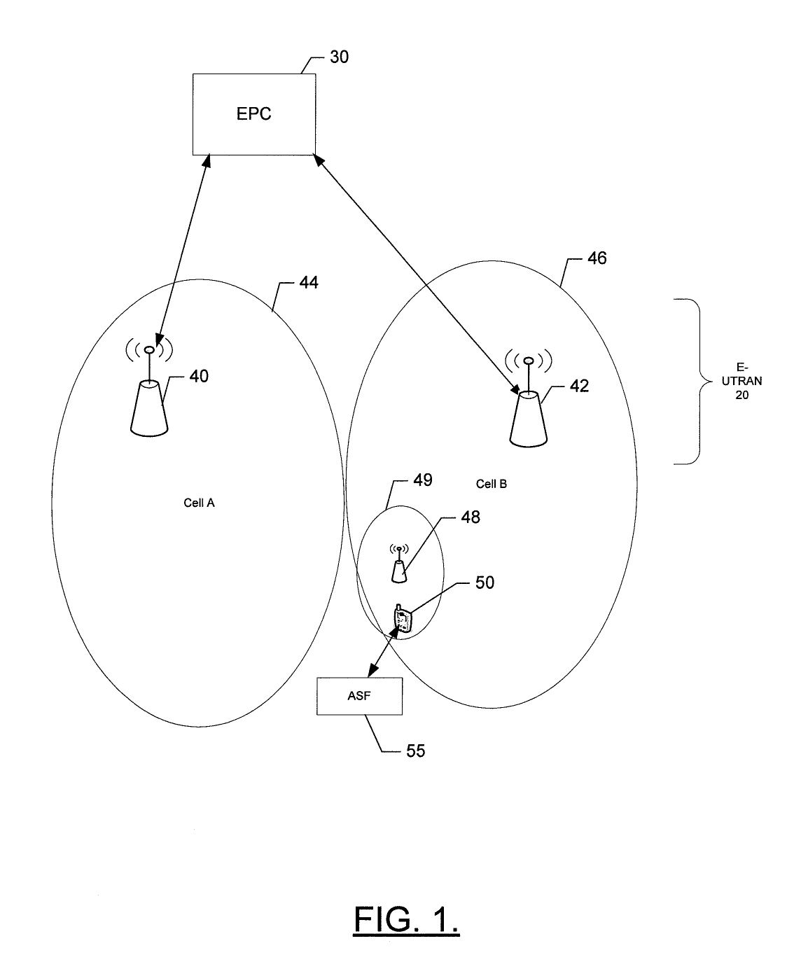

FIG. 1 illustrates a schematic block diagram showing a system for providing improved autonomous search function performance according to an example embodiment of the present invention. However, it should be appreciated that FIG. 1 is illustrative of one example embodiment, and thus it should be understood that other architectures including additional or even fewer elements may also be employed in connection with practicing other example embodiments of the present invention. Furthermore, the system of FIG. 1 illustrates a network embodied as an E-UTRAN, however, any other network could alternatively be substituted in alternative embodiments.

Referring now to FIG. 1, the system may include an E-UTRAN 20 which may include, among other things, a plurality of node-Bs in communication with an evolved packet core (EPC) 30 which may include one or more mobility management entities (MMEs) and one or more system architecture evolution (SAE) gateways. The node-Bs may be evolved node-Bs (e.g., eNBs 40 and 42) that may each have corresponding cells (cell A 44 and cell B 46) that define the coverage area of the respective eNBs. In some cases, one or more of the eNBs 40 and 42 may be CSG/hybrid HeNBs and the corresponding cells (e.g., cell A 44 and cell B 46) may therefore be CSG/hybrid cells. One or more access points (APs) associated with another communication protocol (e.g., WiFi) may also be included within the system. AP 48 is an example such an AP, and AP 48 may be assumed to be associated with wireless local area networks (WLAN), Worldwide Interoperability for Microwave Access (WiMAX), WiFi or some other short range communication protocol (e.g., an institute of electrical and electronics engineers (IEEE) 802.11 related network). The AP 48 may have a corresponding cell 49 that is generally smaller in size (and therefore more geographically limited in coverage) than cell A 44 or cell B 46. The AP 48 and/or the eNBs 40 and 42 may be capable of communication with a UE 50 and one or more other UEs (some of which may be members of a closed subscriber group (CSG)). Although FIG. 1 only shows a specific number of eNBs, APs and UEs, there could be a plurality of nodes and mobile terminals included in the system. The E-UTRAN 20 may be in communication with the EPC 30 as part of an EPS (Evolved Packet System). Moreover, although FIG. 1 shows eNBs, NBs, base stations (BS) or other APs may be employed in connection with embodiments that operate in accordance with other radio access technologies (RATs).

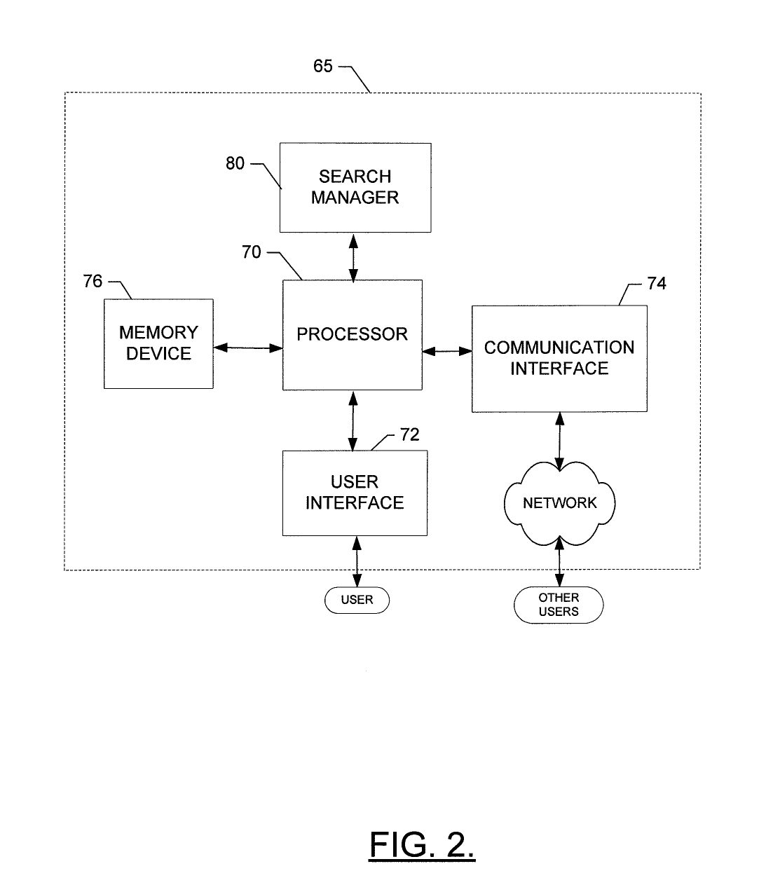

In an exemplary embodiment, the UE 50 may be a communication device such as a computer (e.g., a personal computer, laptop, server, or the like), a mobile telephone, global positioning system (GPS) device, a personal digital assistant (PDA), pager, mobile television, gaming device, camera, audio/video player, radio, or any combination of the aforementioned, and other types of electronic devices that may include a processor and/or memory for executing various hardware and/or software processes. The UE 50 may be configured to employ processing in accordance with embodiments of the present invention as described in greater detail below in connection with the description of FIG. 2.

Although not necessary, in some embodiments, the UE 50 may be capable of communicating in accordance with any one or more of a number of first-generation (1G), second-generation (2G), 2.5G, third-generation (3G), 3.5G, 3.9G, fourth-generation (4G) mobile communication protocols, LTE, and/or the like. As such, for example, the UE 50 may communicate with other UEs or network devices via a network and the UE 50 may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the UE 50. By directly or indirectly connecting the UE 50 to other devices, the UE 50 may be enabled to communicate with the other devices, for example, according to numerous communication protocols including Hypertext Transfer Protocol (HTTP) and/or the like, to thereby carry out various communication or other functions of the UE 50.

In an example embodiment, the UE 50 may include one or more receivers, antennas and/or receiving circuitry to enable the UE 50 to receive and decode signaling associated with one or more communication protocols or RAT frequencies. Thus, for example, the UE 50 may include receiving circuitry for RF communication with the eNB 40 or 42 via E-UTRAN and the UE 50 may include receiving circuitry for WiFi communication with AP 48.

The eNBs 40 and 42 may provide E-UTRA user plane and control plane (e.g. radio resource control (RRC)) protocol terminations for the UE 50 and other UEs . The eNBs 40 and 42 may provide functionality hosting for such functions as radio resource management, radio bearer control, radio admission control, connection mobility control, dynamic allocation of resources to UEs in both uplink and downlink, selection of an MME at UE attachment, Internet Protocol (IP) header compression and encryption, scheduling of paging and broadcast information, routing of data, measurement and measurement reporting for configuration mobility, and/or the like. Each eNB may, in some cases, represent a separate cell (e.g., cell A 44 and cell B 46) capable of servicing UEs within the cell with respect to communication services in accordance with E-UTRAN techniques. The cells may overlap in some cases and various smaller cells associated with other communication protocols (e.g., WiFi hotspots such as AP 48) may be included within or overlapping with the boundaries of the separate cells.

The MME may host functions such as distribution of messages to respective node-Bs, security control, idle state mobility control, EPS bearer control, ciphering and integrity protection, and/or the like. In an exemplary embodiment, the MME may include an access control manager, which may be configured to determine whether network access is to be allowed or rejected for particular users. The SAE gateway may host functions such as termination and switching of certain packets for paging and support of UE mobility. In an exemplary embodiment, the EPC 30 may provide connection to a network such as the Internet.

In an exemplary embodiment, one or more CSGs may be defined and may be serviced by a particular eNB (e.g., eNBs 40 and/or 42). Thus, for example, if the UE 50 is in an area (e.g., a cell) where communication with eNB 42 is possible, the UE 50 may be aware that potential communication with the eNB 42 is possible. Similarly, if the UE 50 is in an area where communication with eNB 40 is possible, the UE 50 may also be aware that potential communication with the eNB 40 is possible. However, if either of the eNBs 40 and 42 are associated with CSGs, access restrictions may apply with respect to the UE 50.

In this regard, for example, if one assumes that eNB 40 is associated with a CSG to which UE 50 does not have access rights, the UE 50 may be prevented from accessing the CSG associated with eNB 40. However, if eNB 42 is associated with a CSG to which the UE 50 has access rights, the UE 50 may be enabled to access the CSG associated with the eNB 42. As such, for example, the eNB 42 may be considered to be associated with an accessible CSG cell with respect to the UE 50 and the eNB 40 may be considered to be associated with a non-accessible cell with respect to the UE 50.

In an example embodiment, the UE 50 may include an access manager, that may be configured to provide CSG access control functionality. In this regard, for example, the access manager may be configured to maintain or store identities of cells that are not accessible to the UE 50 in order, for example, to prevent the UE 50 from consuming resources by making multiple access attempts to non-accessible CSG cells. Accordingly, for example, the access manager 80 may store a whitelist including a listing of CSG cells for which the UE 50 has access rights and/or a blacklist or forbidden list including a listing of CSG cells for which the UE 50 does not have access rights.

The UE 50 may also include an automated search function (ASF) 55 that may be supported by components described in greater detail below in connection with the description of FIG. 2. The ASF 55 may provide functionality for finding previously visited and allowed or accessible CSG/hybrid cells as described herein. As such, the ASF may include functionality that incorporates the storage of information associated with locations of access points associated with two different RATs (e.g., WiFi and E-UTRAN). In particular, the information stored may correlate CSG cell locations with corresponding WiFi hotspots or other more geographically accurately locatable access points. In this regard, since a WiFi hotspot (as an example) has a smaller geographic coverage area, its location is more accurate than the location of a cell (e.g., cell A 44 or cell B 46) associated with E-UTRAN. Thus, by storing access point footprint information associated with locations of both the larger cell and the smaller cell, more accurate information may be known with respect to location when proximity indication messages are formulated. Thus, resources may be spared in relation to handovers, measurement overhead and UE battery life.

Referring now to FIG. 2, an apparatus 65 for enabling the provision of an improved autonomous search function is provided. The apparatus 65 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with example embodiments of the present invention. For example, the memory device 76 could be configured to buffer input data for processing by the processor 70. Additionally or alternatively, the memory device 76 could be configured to store instructions for execution by the processor 70.

The apparatus 65 may, in some embodiments, be a user terminal (e.g., UE 50) that may operate independent of or in connection with a network. However, in some embodiments, the apparatus 65 may be instantiated at one or more of the network device or the UE 50. Thus, the apparatus 65 may be any computing device configured to employ an example embodiment of the present invention. However, in some embodiments, the apparatus 65 may be embodied as a chip or chip set (which may in turn be employed at one of the devices mentioned above). In other words, the apparatus 65 may comprise one or more physical packages (e.g., chips) including materials, components and/or wires on a structural assembly (e.g., a baseboard). The apparatus 65 may, in some cases, form a portion, component, or group of components of a larger device (e.g., UE 50). The structural assembly may provide physical strength, conservation of size, and/or limitation of electrical interaction for component circuitry included thereon. The apparatus 65 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen(s), touch areas, soft keys, a microphone, a speaker, or other input/output mechanisms. In an example embodiment in which the apparatus 65 is embodied as a server or some other network devices, the user interface 72 may be limited, or eliminated. However, in an embodiment in which the apparatus 65 is embodied as a communication device (e.g., the UE 50), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the processor 70 may be embodied as, include or otherwise control a search manager 80. As such, in some embodiments, the processor 70 may be said to cause, direct or control the execution or occurrence of the various functions attributed to the search manager 80 as described herein. The search manager 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the search manager 80 as described herein. Thus, in examples in which software is employed, a device or circuitry (e.g., the processor 70 in one example) executing the software forms the structure associated with such means.

In some embodiments, the search manager 80 may be configured to facilitate provision of proximity indications in a more accurate manner. In this regard, the search manager 80 may be configured to discover (e.g., at the UE 50), a first access node (e.g., eNB 42) providing access in accordance with a first RAT (e.g., UTRAN or E-UTRAN) where the first access node is associated with a CSG accessible to the UE 50. The search manager 80 may be further configured to cause an attempt to discover a second access node (e.g., AP 48) providing access in accordance with a second RAT, according to some example embodiments, in response to discovering the first access node. The search manager 80 may be further configured to cause storage of fingerprint information associated with the first access node in association with storage of fingerprint information associated with the second access node for future use in connection with CSG cell discovery. In some embodiments, the search manager 80 may be further configured to report the fingerprint information associated with the first access node and the fingerprint information associated with the second access node to a network device (e.g., eNB 42). In some embodiments, the search manager 80 may be further configured to initiate an attempt to discover the second access node in response to a subsequent discovery of the first access node and cause generation of a proximity indication message in response to the second access node being discovered in connection with discovery of the first access node.

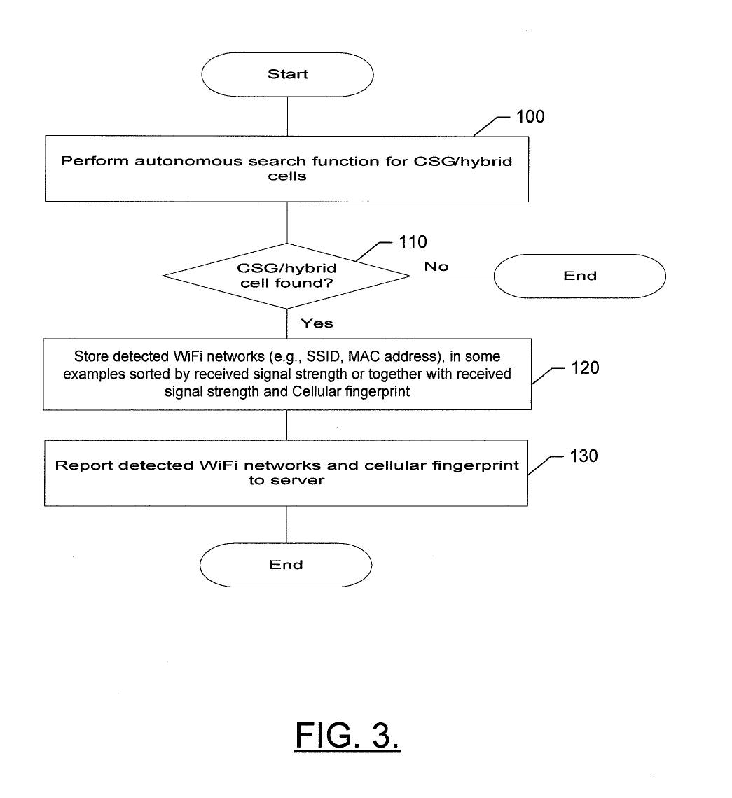

FIG. 3 illustrates a flow chart showing some of the activities managed by the search manager 80 according to an example embodiment. In some cases, the activities shown in FIG. 3 may be performed while the UE 50 is in an idle mode. In this regard, as shown at operation 100, an autonomous search function may be performed for CSG/hybrid cells. A determination may then be made as to whether any CSG/hybrid cell (e.g., an allowed CSG cell) is found at operation 110. If a CSG/hybrid cell is found, information regarding any WiFi networks that are detectable may be recorded at operation 120. In some cases, signal parameters associated with the WiFi network such as, for example, service set identifier (SSID), MAC address, received signal strength and other information may be recorded as a WiFi fingerprint or WiFi fingerprint information. In some cases, the information regarding detectable WiFi networks (e.g., WiFi fingerprint information) may be recorded along with a cellular fingerprint (e.g., a macro cell RF fingerprint indicative of RF cell location for an allowed CSG cell). The information regarding detectable WiFi networks may, in some cases, be sorted by signal strength. In some cases, the recorded information (e.g., the WiFi fingerprint information and corresponding cellular fingerprint) may be reported to a server or other network device (e.g., in the operator's network) at operation 130. The reporting of the recorded information may enable the server to store information associated with multiple UEs. The reporting of the recorded information may also enable the server to provide that information to UEs as needed to facilitate accurate proximity indication generation given that, for example, the fingerprint information associated with the WiFi network may be more accurate as an indication of location within a larger coverage area of a macro cell than the fingerprint information of the cellular macro cell.

In an example embodiment, the recorded information may be employed by an ASF of the UE 50 in either idle mode or connected mode in order to improve CSG location determination, which may reduce UE power consumption related to CSG search. For example, once the UE 50 is in the connected mode, and the ASF recognizes the overlaying macro cell RF fingerprint, the UE 50 may activate (if not currently activated) the WiFi receiver of the UE 50 in order to search for stored WiFi networks. If a WiFi network is detected that matches a WiFi fingerprint, then both the stored WiFi fingerprint and the corresponding stored cellular fingerprint may match and a proximity indication may be triggered. By triggering the proximity indication in this manner, the accuracy of the proximity indication may be improved. As an alternative, instead of activating the WiFi receiver in response to detection of an allowed CSG cell, an active WiFi receiver may detect a WiFi network matching stored WiFi fingerprint information provided to the ASF and that may cause the UE 50 to determine whether an overlaying macro cell RF fingerprint is also present to trigger the proximity indication message.

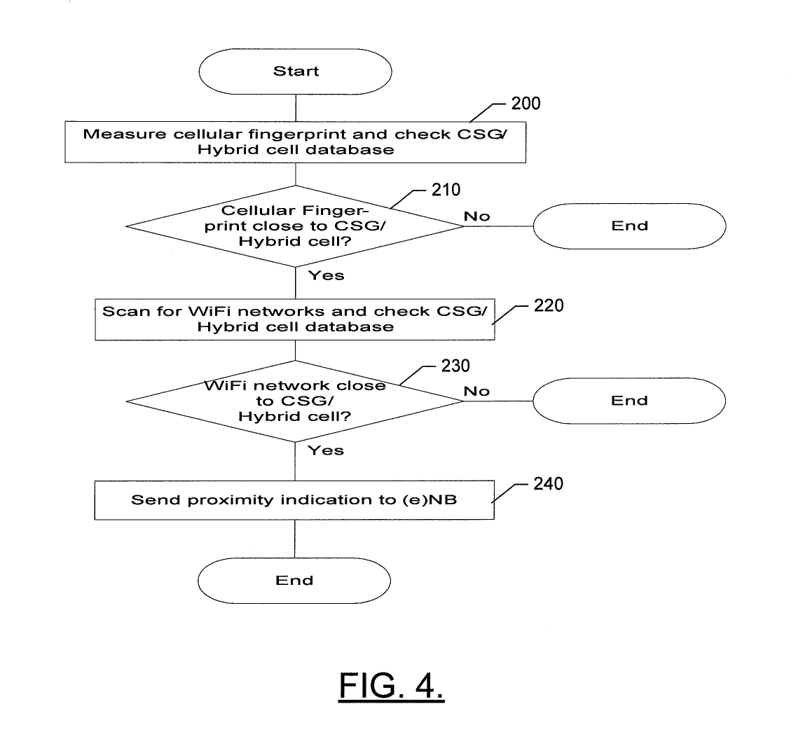

FIG. 4 illustrates an example of the use of WiFi fingerprint information and cellular fingerprint information for triggering proximity indication messages according to an example embodiment. In this regard, as shown in FIG. 4, a cellular fingerprint may be measured and a check may be made against a CSG/hybrid database at operation 200 to determine whether the CSG/hybrid cell corresponding to a detected cellular fingerprint is an allowed CSG cell. A determination may then be made as to whether the measured cellular fingerprint indicates that the UE 50 is close to an allowed CSG/hybrid cell at operation 210. If the UE 50 is near (e.g., within communication range) an allowed CSG/hybrid cell, the UE 50 may initiate a WiFi scan to attempt to discover any WiFi networks and check stored information to see if any detected WiFi network WiFi fingerprints match correspondingly recorded cellular fingerprint information at operation 220. A determination is then made as to whether a WiFi network is near (e.g., within communication range) to a corresponding previously recorded CSG/hybrid cell at operation 230. If the WiFi network is determined to be near (e.g., WiFi fingerprint and corresponding cellular fingerprint information match), then a proximity indication may be sent to the corresponding eNB at operation 240.

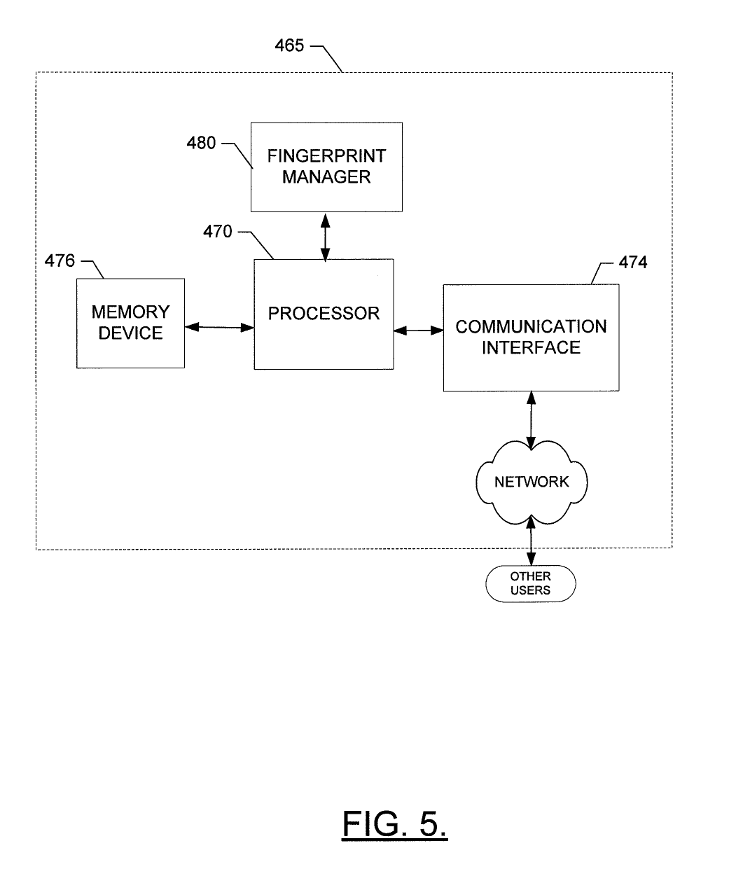

In some cases, a network entity may also include an apparatus for supporting operation of an example embodiment. FIG. 5 illustrates an example of such an apparatus 465. As shown in FIG. 5, the apparatus 465 may include a processor 470, a communication interface 474 and a memory device 476. The processor 470, the communication interface 474 and the memory device 476 may be similar in basic form and function to the processor 70, communication interface 74, and memory device 76, respectively, of FIG. 2 except that there may be size and semantic differences in some cases. The apparatus 465 may also include a fingerprint manager 480. The fingerprint manager 480 may be embodied as a network node configured to receive information about detected WiFi networks together with cellular fingerprint information. Information (e.g., including WiFi fingerprints and cellular fingerprints) from multiple UEs may be combined and the combined information may be provided to other UEs.

Example embodiments may therefore provide for storage of cellular fingerprint information along with WiFi fingerprint information that may, for example, be used in some embodiments to improve accuracy of proximity indication generation. However, it should be appreciated that example embodiments may also be practiced in the context of other types of networks where it may be advantageous within a macro cell to more narrowly identify location using information indicative of a nearby femto or pico cell to, for example, facilitate more efficient discovery of CSG cells.

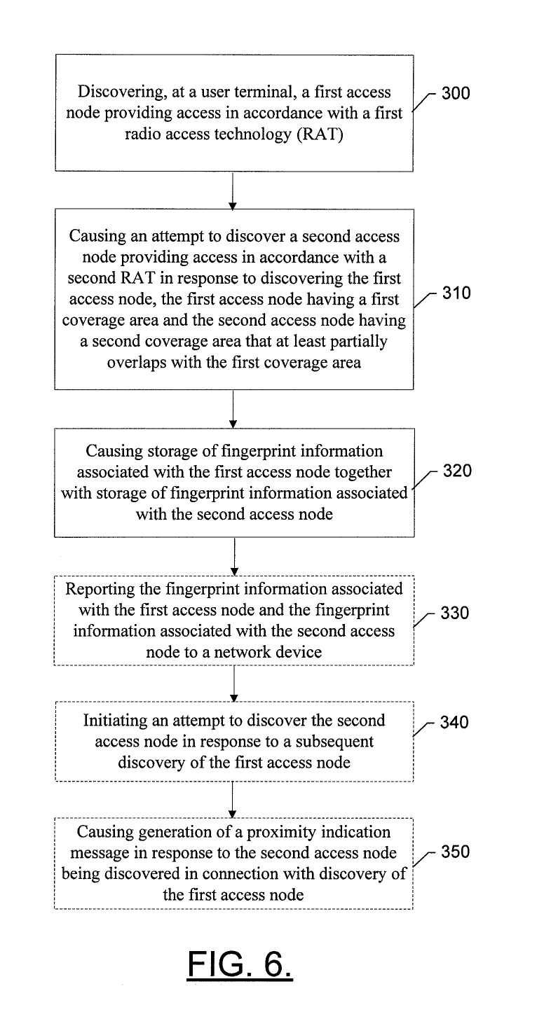

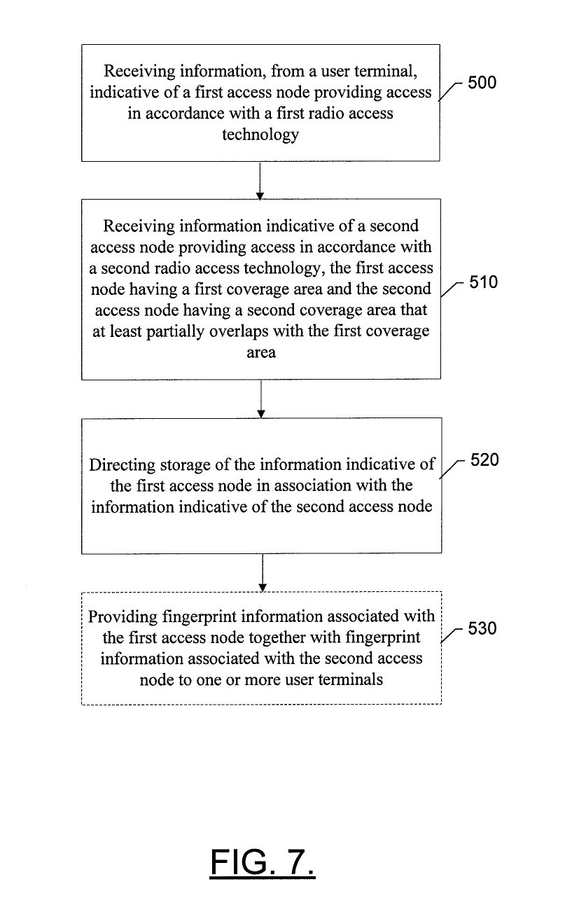

FIGS. 6 and 7 are flowcharts of a system, method and program product according to some example embodiments of the invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus embody a mechanism for implementing the functions specified in the flowcharts block(s). These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the function specified in the flowcharts block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts block(s). As such, the operations of FIGS. 6 and 7, when executed, convert a computer or processing circuitry into a particular machine configured to perform an example embodiment of the present invention. Accordingly, the operations of FIGS. 6 and 7 define an algorithm for configuring a computer or processing circuitry (e.g., processor 70 or processor 470) to perform an example embodiment. In some cases, a general purpose computer may be provided with an instance of the search manager 80 or fingerprint manager 480, which performs the algorithm shown in FIGS. 6 and 7 (e.g., via configuration of the processor 70 or processor 470), to transform the general purpose computer into a particular machine configured to perform an example embodiment.

Accordingly, blocks of the flowchart support combinations of means for performing the specified functions, combinations of operations for performing the specified functions and program instructions for performing the specified functions. It will also be understood that one or more blocks of the flowchart, and combinations of blocks in the flowchart, can be implemented by special purpose hardware-based computer systems which perform the specified functions or operations, or combinations of special purpose hardware and computer instructions.

In this regard, one embodiment of a method according to an example embodiment practiced in a UE as shown in FIG. 6 may include discovering, at a user terminal, a first access node providing access in accordance with a first radio access technology (RAT) at operation 300. In some cases, the first access node may be associated with a closed subscriber group (CSG) accessible to the user terminal. The method may further include causing an attempt to discover a second access node providing access in accordance with a second RAT in response to discovering the first access node where the first access node has a first coverage area and the second access node has a second coverage area that at least partially overlaps with the first coverage area and may be smaller than the first coverage area at operation 310, and causing storage of fingerprint information associated with the first access node in association with or together with storage of fingerprint information associated with the second access node at operation 320.

In some embodiments, certain ones of the operations above may be modified or further amplified as described below. Moreover, in some embodiments additional optional operations may also be included (some examples of which are shown in dashed lines in FIG. 6). It should be appreciated that each of the modifications, optional additions or amplifications below may be included with the operations above either alone or in combination with any others among the features described herein. In an example embodiment, the method may further include reporting the fingerprint information associated with the first access node and the fingerprint information associated with the second access node to a network device at operation 330. In some embodiments, the method may additionally or alternatively include initiating an attempt to discover the second access node in response to a subsequent discovery of the first access node at operation 340. In some cases, the method may additionally or alternatively include causing generation of a proximity indication message in response to the second access node being discovered in connection with discovery of the first access node at operation 350. In an example embodiment, initiating the attempt to discover the second access node may include initiating the attempt while the user terminal is in an idle mode or a connected mode. In some embodiments, discovering the first access node may include discovering a communication node associated with UTRAN or E-UTRAN, and causing the attempt to discover the second access node may include causing an attempt to discover an access point associated with WiFi. In some cases, causing storage of fingerprint information further comprises causing storage of signal parameters (e.g., SSID, MAC address, received signal strength, etc.) associated with the second access node.

In an example embodiment, an apparatus for performing the method of FIG. 6 above may comprise one or more processors (e.g., the processor 70) configured to perform some or each of the operations (300-350) described above. The processor 70 may, for example, be configured to perform the operations (300-350) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 300-350 may comprise, for example, the search manager 80. Additionally or alternatively, at least by virtue of the fact that the processor 70 may be configured to control or even be embodied as the search manager 80, the processor 70 and/or a device or circuitry for executing instructions or executing an algorithm for processing information as described above may also form example means for performing operations 300-350.

An example of an apparatus according to an example embodiment may include at least one processor and at least one memory including computer program code. The at least one memory and the computer program code may be configured to, with the at least one processor, cause the apparatus to perform the operations 300-350 (with or without the modifications and amplifications described above in any combination).

An example of a computer program product according to an example embodiment may include at least one computer-readable storage medium having computer-executable program code portions stored therein. The computer-executable program code portions may include program code instructions for performing operation 300-350 (with or without the modifications and amplifications described above in any combination).

In some cases, the operations (300-350) described above, along with any of the modifications may be implemented in a method that involves facilitating access to at least one interface to allow access to at least one service via at least one network. In such cases, the at least one service may be said to perform at least operations 300-350.

FIG. 7 illustrates an alternative embodiment of a method according to an example embodiment practiced, for example, in a network node. The method may include receiving information, for example from a user terminal, indicative of a first access node providing access in accordance with a first radio access technology at operation 500. The first access node may be associated with a closed subscriber group accessible to the user terminal. The method may further include receiving information indicative of a second access node providing access in accordance with a second radio access technology. The first access node may have a first coverage area and the second access node may have a second coverage area that at least partially overlaps with the first coverage area. The method may further include directing storage of the information indicative of the first access node in association with the information indicative of the second access node (in some cases along with information indicative of other first access nodes and second access nodes received from other user terminals) at operation 520. The method may further include providing fingerprint information associated with the first access nodes together with fingerprint information associated with the second access nodes to one or more of the user terminals at operation 530.

In an example embodiment, an apparatus for performing the method of FIG. 7 above may comprise one or more processors (e.g., the processor 470) configured to perform some or each of the operations (500-530) described above. The processor 470 may, for example, be configured to perform the operations (500-530) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 500-530 may comprise, for example, the fingerprint manager 480. Additionally or alternatively, at least by virtue of the fact that the processor 470 may be configured to control or even be embodied as the fingerprint manager 480, the processor 470 and/or a device or circuitry for executing instructions or executing an algorithm for processing information as described above may also form example means for performing operations 500-530.

An example of an apparatus according to an example embodiment may include at least one processor and at least one memory including computer program code. The at least one memory and the computer program code may be configured to, with the at least one processor, cause the apparatus to perform the operations 500-530 (with or without the modifications and amplifications described above in any combination).

An example of a computer program product according to an example embodiment may include at least one computer-readable storage medium having computer-executable program code portions stored therein. The computer-executable program code portions may include program code instructions for performing operation 500-530 (with or without the modifications and amplifications described above in any combination).

In some cases, the operations (500-530) described above, along with any of the modifications may be implemented in a method that involves facilitating access to at least one interface to allow access to at least one service via at least one network. In such cases, the at least one service may be said to perform at least operations 500-530.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
discovering, at a processor, a first access node providing access in accordance with a first radio access technology;
causing an attempt to discover a second access node providing access in accordance with a second radio access technology, the first access node having a first coverage area and the second access node having a second coverage area that at least partially overlaps with the first coverage area; and
causing storage of fingerprint information associated with the first access node together with storage of fingerprint information associated with the second access node.

2. The method of claim 1, further comprising reporting the fingerprint information associated with the first access node and the fingerprint information associated with the second access node to a network device.

3. The method of claim 1, further comprising causing generation of a proximity indication message in response to the second access node being discovered.

4. The method of claim 1, wherein causing the attempt to discover the second access node comprises causing the attempt while a user terminal is in an idle mode or a connected mode.

5. The method of claim 1, wherein discovering the first access node comprises discovering a communication node associated with universal mobile telecommunications system (UMTS) terrestrial radio access network (UTRAN) or evolved UTRAN (E-UTRAN), and wherein causing the attempt to discover the second access node comprises causing an attempt to discover an access point associated with WiFi.

6. The method of claim 1, wherein causing storage of fingerprint information further comprises causing storage of signal parameters associated with the second access node.

7. The method of claim 1, wherein the first access node is associated with a closed subscriber group accessible to a user terminal, a hybrid access node, or an open femto cell.

8. The method of claim 1, causing storage of fingerprint information associated with a third access node in association with storage of fingerprint information associated with the first and second access nodes.

9. The method of claim 1, wherein causing the attempt to discover the second access node includes using the fingerprint information associated with the second access node which is stored with the fingerprint information associated with the first access node.

10. An apparatus comprising at least one processor and at least one memory including computer program code, the at least one memory and the computer program code configured to, with the at least one processor, cause the apparatus to at least:
discover, at a user terminal, a first access node providing access in accordance with a first radio access technology;
cause an attempt to discover a second access node providing access in accordance with a second radio access technology, the first access node having a first coverage area and the second access node having a second coverage area that at least partially overlaps with the first coverage area; and
cause storage of fingerprint information associated with the first access node together with storage of fingerprint information associated with the second access node.

11. The apparatus of claim 10, wherein the at least one memory and computer program code are further configured to, with the at least one processor, cause the apparatus to report the fingerprint information associated with the first access node and the fingerprint information associated with the second access node to a network device.

12. The apparatus of claim 10, wherein the at least one memory and computer program code are further configured to, with the at least one processor, cause the apparatus to cause generation of a proximity indication message in response to the second access node being discovered.

13. The apparatus of claim 10, wherein the at least one memory and computer program code are configured to, with the at least one processor, cause the apparatus to initiate the attempt to discover the second access node by initiating the attempt while the user terminal is in an idle mode or a connected mode.

14. The apparatus of claim 10, wherein the at least one memory and computer program code are configured to, with the at least one processor, cause the apparatus to discover the first access node by discovering a communication node associated with universal mobile telecommunications system (UMTS) terrestrial radio access network (UTRAN) or evolved UTRAN (E-UTRAN), and to cause the attempt to discover the second access node by causing an attempt to discover an access point associated with WiFi.

15. The apparatus of claim 9, wherein the at least one memory and computer program code are configured to, with the at least one processor, cause the apparatus to cause storage of fingerprint information by causing storage of signal parameters associated with the second access node.

16. The apparatus of claim 9, wherein the first access node is associated with a closed subscriber group accessible to the user terminal, a hybrid access node, or an open femto cell.

17. The apparatus of claim 9, wherein the at least one memory and computer program code are configured to, with the at least one processor, cause the apparatus to cause storage of fingerprint information associated with a third access node in association with storage of fingerprint information associated with the first and second access nodes.

18. The apparatus of claim 9, wherein the at least one memory and the computer program code are configured to, with the at least one processor, cause the attempt to discover the second access node by using the fingerprint information associated with the second access node which is stored with the fingerprint information associated with the first access node.

19. An apparatus comprising at least one processor and at least one memory including computer program code, the at least one memory and the computer program code configured to, with the at least one processor, cause the apparatus to at least:
receive information, from a user terminal, indicative of a first access node providing access in accordance with a first radio access technology;
receive information indicative of a second access node providing access in accordance with a second radio access technology, the first access node having a first coverage area and the second access node having a second coverage area that at least partially overlaps with the first coverage area; and
directing storage of the information indicative of the first access node in association with the information indicative of the second access node.

20. The apparatus of claim 17, further comprising providing fingerprint information associated with the first access node together with fingerprint information associated with the second access node to one or more user terminals.
